(19) United States
(12) Patent Application Publication
(10) Pub. No.: US 2026/0104630 A1
(43) Pub. Date: Apr. 16, 2026

(54) ROTATING MODULE AND PHOTOGRAPHIC DEVICE

(71) Applicant: SHENZHEN LEQI INNOVATION CO., LTD., SHENZHEN (CN)

(72) Inventors: JIAWEI XU, SHENZHEN (CN); XINGXING YUAN, SHENZHEN (CN); LIANG GUO, SHENZHEN (CN); ZHIQIANG PAN, SHENZHEN (CN)

(21) Appl. No.: 19/247,310

(22) Filed: Jun. 24, 2025

(30) Foreign Application Priority Data
Jul. 4, 2024 (CN) 202421581881.6

(51) Int. Cl. G03B 17/56; F16M 11/08

(52) U.S. Cl. CPC G03B 17/561; F16M 11/08; G03B 17/563; G03B 17/566; F16M 2200/021

(57) ABSTRACT

A rotating module and a photographic device are provided. A housing of the rotating module is internally provided with a mounting cavity for being connected with one of two components. A connecting member is disposed through the mounting cavity for being connected with the other of the two components. A first transmission member and a second transmission member of a locking mechanism are oppositely arranged along an axial direction of the connecting member and sleeved on the connecting member, a plurality of abutting members are arranged between the first transmission member and the second transmission member and are sequentially arranged at intervals along a circumferential direction of the connecting member, and the plurality of abutting members are respectively connected with the first transmission member and the second transmission member; a manipulation assembly is configured to drive the first transmission member and the second transmission member to move.

### TECHNICAL FIELD

The present disclosure relates to the field of photographic devices, in particular to a rotating module and a photographic device.

### BACKGROUND

In order to get a stable and clear picture in a shooting process, a tripod has become an indispensable auxiliary equipment for photographers.

In related art, mainly, the camera is directly screwed on the tripod for fixing. In the shooting process, the camera is fixed on a top plate of the tripod by tripod screws, which ensures stability of shooting equipment.

However, there are some disadvantages in this way of screwing the camera directly on the tripod for fixing. In adjusting a shooting position, a user needs to rotate the camera together with the tripod, which is not only time-consuming and inconvenient to operate, but also is particularly troublesome when a shooting angle needs to be changed quickly.

### SUMMARY

A main object of the disclosure is to propose a rotating module, which aims to solve a problem that a user needs to rotate the camera together with the tripod in adjusting a shooting position.

### In order to achieve the above object, a rotating module is provided in the disclosure, which includes:

a housing defined with a mounting cavity inside; a connecting member which is disposed through the mounting cavity and is capable of being movable or fixed relative to the housing, the connecting member being configured to be connected with a photographic equipment; and a locking mechanism arranged in the housing, the locking mechanism including a manipulation assembly, a first transmission member, a second transmission member, and a plurality of abutting members, the first transmission member and the second transmission member being oppositely arranged along an axial direction of the connecting member and sleeved on the connecting member, the plurality of abutting members being arranged between the first transmission member and the second transmission member at intervals in sequence along a circumferential direction of the connecting member, and the plurality of abutting members being respectively connected with the first transmission member and the second transmission member and capable of moving towards or away from the connecting member; the manipulation assembly being arranged at an outer wall of the housing, an execution end of the manipulation assembly extending into the housing and being in drive connection with the first transmission member and the second transmission member, for driving the first transmission member and the second transmission member to move to drive the plurality of the abutting members to move towards the connecting member to clamp the connecting member so as to fix an shooting angle of the photographic equipment, or to move away from the connecting member to release the connecting member to make the shooting angle of the photographic equipment adjustable.

In some embodiments, the first transmission member includes a first annular transmission frame and a second annular transmission frame. The first annular transmission frame is docked with the second annular transmission frame and is relatively rotatably mounted at an opening of an end of the mounting cavity.

The second transmission component includes a third annular transmission frame and a fourth annular transmission frame. The third annular transmission frame is docked with the fourth annular transmission frame and is relatively rotatably mounted at an opening of the other end of the mounting cavity.

The first annular transmission frame, the second annular transmission frame, the third annular transmission frame, and the fourth annular transmission frame are each provided with a guiding structure corresponding to the plurality of abutting members, and the plurality of abutting members are movably connected with the guiding structures. In case the manipulation assembly drives the first transmission member and the second transmission member to move, the first annular transmission frame and the second annular transmission frame can be rotated relative to each other, the third annular transmission frame and the fourth annular transmission frame can be rotated relative to each other, and the guide structures can guide the plurality of abutting members to move towards the connecting member to clamp the connecting member or to move away from the connecting member to release the connecting member.

In some embodiments, the guide structure includes a group of guide holes, and guide holes in the group of guide holes are sequentially arranged at intervals along the circumferential direction of the connecting member.

In some embodiments, the group of guide holes includes a plurality of first guide holes and a plurality of second guide holes defined in the first annular transmission frame, the second annular transmission frame, the third annular transmission frame, and the fourth annular transmission frame, the plurality of first guide holes and the plurality of second guide holes are sequentially and alternately arranged at intervals.

One end of each of the plurality of abutting members is inserted into a first guide hole and a second guide hole that are staggered and respectively defined in the first annular transmission frame and the second annular transmission frame, and the other end of the abutting member is inserted into a first guide hole and a second guide hole that are staggered and respectively defined in the third annular transmission frame and the fourth annular transmission frame.

In some embodiments, the first guide hole is arranged to extend along a radial direction of a central axis of the connecting member, and the second guide hole is arranged to extend along a circumferential direction of a central axis of the connecting member.

In some embodiments, the plurality of abutting members at least include a first roller shaft and a second roller shaft.

One end of the first roller shaft passes through the first guide hole of the first annular transmission frame and is inserted into the second guide hole of the second annular transmission frame. The other end of the first roller shaft passes through the second guide hole of the third annular transmission frame and is inserted into the first guide hole of the fourth annular transmission frame.

One end of the second roller shaft passes through the second guide hole of the first annular transmission frame and is inserted into the first guide hole of the second annular transmission frame. The other end of the second roller shaft passes through the first guide hole of the third annular transmission frame and is inserted into the second guide hole of the fourth annular transmission frame.

In some embodiments, side edges of the first annular transmission frame, the second annular transmission frame, the third annular transmission frame and the fourth annular transmission frame are each provided with a transmission handle.

A first driving linkage is connected between the transmission handle of the first annular transmission frame and the transmission handle of the third annular transmission frame.

A second driving linkage is connected between the transmission handle of the second annular transmission frame and the transmission handle of the fourth annular transmission frame.

The first driving linkage and the second driving linkage are driven by the manipulation assembly to move away from each other to drive the first annular transmission frame and the third annular transmission frame to rotate in a first direction, and to drive the second annular transmission frame and the fourth annular transmission frame to rotate in a second direction. Alternatively, the first driving linkage and the second driving linkage are driven by the manipulation assembly to get close to each other to drive the first annular transmission frame and the third annular transmission frame to rotate in the second direction, and to drive the second annular transmission frame and the fourth annular transmission frame to rotate in the first direction. The second direction is opposite to the first direction.

### In some embodiments, the manipulation assembly includes:

an extrusion member arranged on a side wall of the housing, the extrusion member being at least partially located in the housing, an end of the extrusion member located in the housing being abutted against the first driving linkage and the second driving link, and the extrusion member being configured to move towards the connecting member under an action of an external force to extrude and push the first driving linkage and the second driving link away from each other; and an elastic piece including at least one tension spring, one end of the tension spring being connected with the first driving linkage, and the other end of the tension spring being connected with the second driving linkage, and the tension spring being configured to pull the first driving linkage and the second driving linkage to get close to each other.

In some embodiment, an outer side wall of the housing is configured with two mounting parts which are spaced apart along an axis of the connecting member.

### The manipulation assembly further includes:

an unlocking handle, one end of which is rotatably connected with the two mounting parts and configured to eject the extrusion member to be exposed from an end of the side wall of the housing in rotating.

### In some embodiments, the extrusion member includes:

a pushing rod, an end of the pushing rod away from the connecting member being exposed outside the housing and provided with a mounting groove; and a roller rotatably mounted in the mounting groove, the roller being in rolling contact with an end of the unlocking handle.

In some embodiments, an end of the pushing rod abutted against the first driving linkage and the second driving linkage is configured with a first extrusion surface and a second extrusion surface, and the first extrusion surface and the second extrusion surface are inclined and extend towards each other, the first extrusion surface abuts against the second driving linkage, and the second extrusion surface abuts against the first driving linkage.

In some embodiments, the rotating module further includes:

an abutting disc arranged at an end of the housing, the abutting disc being connected with a part of the connecting member extending out of the mounting cavity and being configured to be abutted against components connected with the connecting member.

In some embodiments, at least one clamping groove is defined in an outer side wall of an end of the connecting member extending out of the mounting cavity.

At least one protrusion is provided in the abutting disc, and the at least one protrusion is clamped and matched with the at least one clamping groove.

A photographic device is further provided in the disclosure, which includes a photographic bracket, a photographic equipment, and the rotating module of the aforementioned embodiments. One end of the rotating module is detachably connected with the photographic bracket, and the other end of the rotating module is detachably connected with the photographic equipment.

In the technical scheme of the disclosure, the mounting cavity is constructed in the housing, which provides a mounting place for the locking mechanism and the connecting member, and the connecting member is detachably connected with the photographic equipment, so that the connecting member can be unlocked or locked through the manipulation assembly, the first transmission member, the second transmission member and the plurality of abutting members of the locking mechanism. When a user needs to adjust a shooting angle of the photographic equipment, the manipulation assembly is driven to drive the first transmission member and the second transmission member to move, thus driving the plurality of abutting members to move away from the connecting member and quickly release the connecting member, so that the shooting angle of the photographic equipment can be adjusted. After the angle is adjusted, the user releases the manipulation assembly, and the first transmission member and the second transmission mechanism drive the plurality of abutting members to move towards the connecting member, so as to quickly clamp the connecting member, thereby fixing the shooting angle of the photographic equipment. This design enables the user to quickly clamp or release the connecting member through a simple operation, to achieve adjusting the shooting angle.

### BRIEF DESCRIPTION OF THE DRAWINGS

FIG. 1 is a schematic structural view of a rotating module according to an embodiment of the disclosure;

FIG. 2 is a schematic structural view of a housing of a rotating module according to an embodiment of the disclosure;

FIG. 3 is a schematic structural view of a locking mechanism of a rotating module according to an embodiment of the disclosure;

FIG. 4 is an exploded structural view of a locking mechanism of a rotating module according to an embodiment of the disclosure;

FIG. 5 is a side view of a rotating module according to an embodiment of the present disclosure;

FIG. 6 is a sectional view taken at A-A in FIG. 5;

FIG. 7 is a sectional view taken at B-B in FIG. 5; and

FIG. 8 is a schematic structural view of a photographic device according to an embodiment of the disclosure.

### Reference numbers are illustrated as follows:

1. photographic device 1; 2. photographic bracket 2; 3. photographic equipment 3; 10. rotating module 10; 100. Housing; 100a. Mounting Cavity; 100b. Mounting Part; 200. Connecting Member; 200a. Clamping Groove; 202. Abutting Disc; 202a. Protrusion; 300. Locking Mechanism; A, Axial Direction; 310. Manipulation Assembly; 310a. execution end 310a of the manipulation assembly; 312. Extrusion Member; 314. pushing rod; 314a. First Extrusion Surface; 314b. Second Extrusion Surface; 314c. Mounting Groove; 316. Roller; 318. Elastic Piece; 319. Unlocking Handle; 320. First Transmission Member; 322. First Annular Transmission Frame; 324. Second Annular Transmission Frame; C. transmission handle; 326. First Driving Linkage; 330. Second Transmission Member; 332. Third Annular Transmission Frame; 334. Fourth Annular Transmission Frame; 336. Second Driving Linkage; E. First Direction; F. Second Direction; 340. Abutting Member; 342. First Roller Shaft; 344. Second Roller Shaft; 400. Guide Structure; 402. Group of Guide Holes; 404. First Guide Hole; 406. Second Guide Hole.

Realization of the object, functional characteristics and advantages of the disclosure will be further explained in combination with embodiments and with reference to attached figures.

### DETAILED DESCRIPTION OF THE EMBODIMENTS

In the following, schemes in the embodiments of the disclosure will be described clearly and completely in connection with the drawings; obviously, the described embodiments are intended to be only a part of embodiments of the disclosure, but not all of them. On a basis of the embodiments in this disclosure, all other embodiments obtained by the ordinary skilled in the art without any creative effort fall within the protection scope of this disclosure.

It should be noted that all of directional indications (such as up, down, left, right, front, back, etc.) in embodiments of the disclosure are only used to illustrate relative position relationships and movement conditions among respective components in a certain posture (as shown). If the certain posture changes, the directional indications vary accordingly.

It should also be noted that when an element is referred to be “fixed” or “provided” on another element, it may be directly on the another element or an intervening element may exist at the same time. When an element is referred to be “connected” to another element, it may be directly connected to the another element or an intervening element may exist at the same time.

In addition, descriptions involving “first”, “second” or the like in this disclosure are only intended for descriptive purposes, and cannot be understood as indicating or implying a relative importance, or implicitly indicating a number of indicated technical features. Therefore, the features defined with “first” and “second” can explicitly or implicitly include at least one of these features. In addition, technical schemes of respective embodiments can be combined with each other, which must be based on enabling of realization by an ordinary skilled in the art. When combination of technical schemes is contradictory or impossible to be realized, it should be considered that such combination of technical schemes does not exist and either is not within the protection scope claimed in this disclosure.

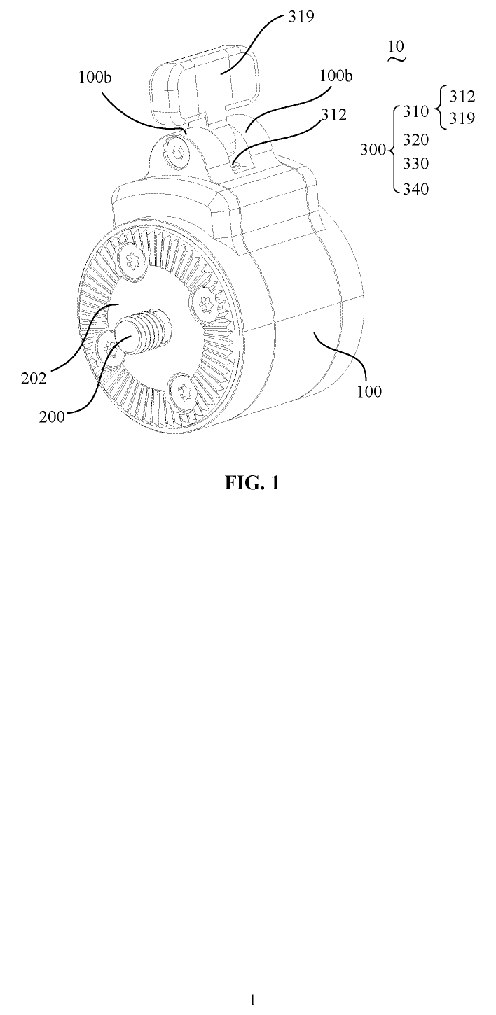

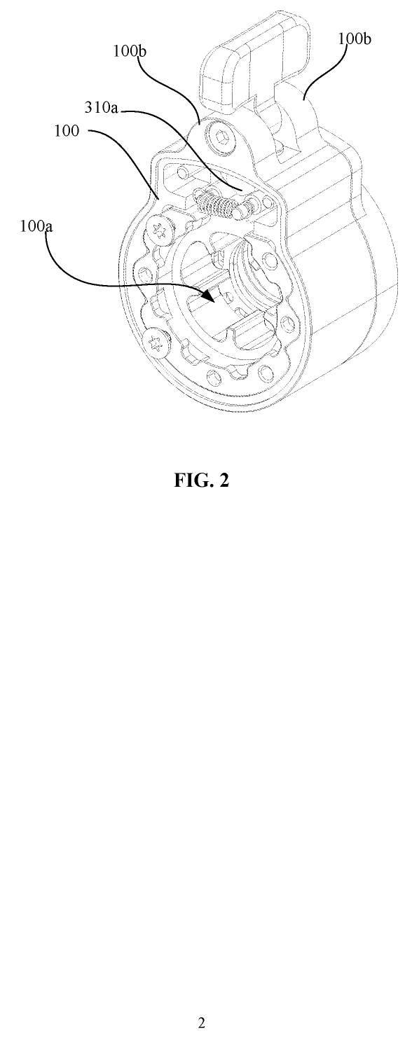

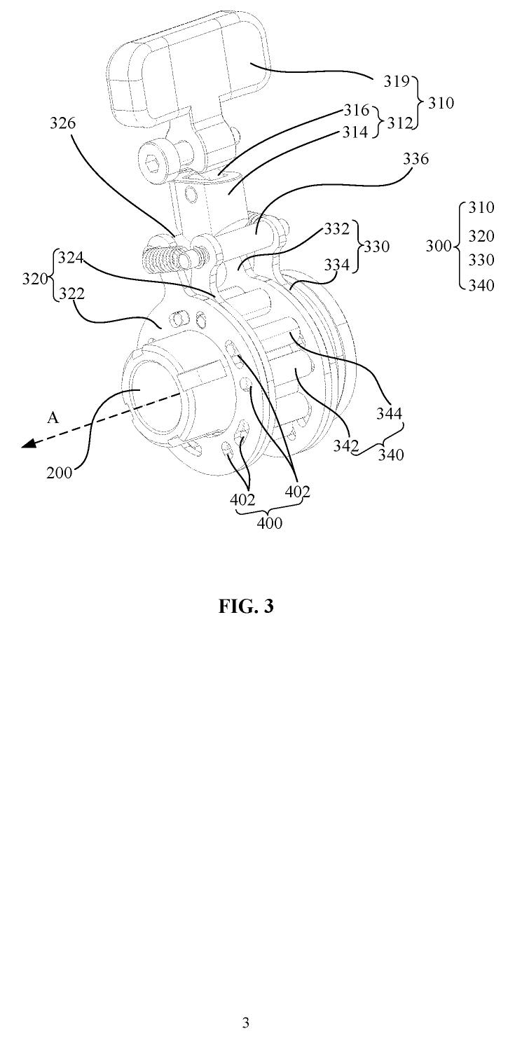

Referring to FIGS. 1 to 3, FIG. 1 is a schematic structural view of a rotating module 10 according to an embodiment of the present disclosure, FIG. 2 is a schematic structural view of a housing of a rotating module 10 according to an embodiment of the present disclosure, and FIG. 3 is a schematic structural view of a locking mechanism of a rotating module 10 according to an embodiment of the present disclosure.

A rotating module 10 is provided in an embodiment of the disclosure, which includes:

a housing 100 defined with a mounting cavity 100a inside; a connecting member 200 which is disposed through the mounting cavity 100a and is capable of being movable or fixed relative to the housing 100, the connecting member 200 being configured to be connected with a photographic equipment; and

a locking mechanism 300 provided in the housing 100, the locking mechanism 300 including a manipulation assembly 310, a first transmission member 320, a second transmission member 330, and a plurality of abutting members 340, the first transmission member 320 and the second transmission member 330 being oppositely arranged along an axial direction A of the connecting member 200 and sleeved on the connecting member 200, and the plurality of abutting members 340 being arranged between the first transmission member 320 and the second transmission member 330 at intervals in sequence along a circumferential direction of the connecting member 200, the plurality of abutting members 340 being respectively connected with the first transmission member 320 and the second transmission member 330 and capable of moving towards or away from the connecting member 200; the manipulation assembly 310 being arranged at an outer wall of the housing 100, an execution end 310a of the manipulation assembly 100 extending into the housing 100 and being in drive connection with the first transmission member 320 and the second transmission member 330, for driving the first transmission member 320 and the second transmission member 330 to move to drive the plurality of the abutting members 340 to move towards the connecting member 200 to clamp the connecting member 200 so as to fix an shooting angle of the photographic equipment, or to move away from the connecting member 200 to release the connecting member 200 to make a shooting angle of the photographic equipment adjustable.

In this embodiment, the housing 100 not only provides a mounting place for respective components, but also functions in connecting two components (the two components in this embodiment can be elements such as a video camera and a tripod, while the housing 100 is mounted on the tripod and the free end of the housing is connected with the video camera). In order to ensure its firmness and durability, the housing 100 can be made of high-strength lightweight materials such as aluminum alloy or carbon fiber, which also can reduce an overall weight.

The connecting member 200 is disposed through the mounting cavity 100a of the housing 100 and can be movable or fixed relative to the housing 100. The connecting member 200 is configured to connect photographic equipment (such as the camera and the tripod) that need to be adjusted in angle, and is fixed or released by the locking mechanism 300. The connecting member 200 may be made of stainless steel or engineering plastics or other materials, the stainless steel has excellent strength and corrosion resistance, while the engineering plastics has characteristics of light weight and easy processing.

The locking mechanism 300 is a core part of the rotating module 10, with a main function of controlling fixing and releasing of the connecting member 200. The manipulation assembly 310 of the locking mechanism 300 is mainly for the user to operate, and the user can control movements of the first transmission member 320 and the second transmission member 330 through the manipulation assembly 310. The manipulation assembly 310 usually exists in a form of a knob, a lever, or a button, and the user can turn or press the manipulation assembly 310 to realize opening or closing of the locking mechanism 300.

The first transmission member 320 of the locking mechanism 300 is mainly responsible for receiving an action of the manipulation assembly 310 and transmitting it to the plurality of abutting members 340. The first transmission member 320 is arranged along the axial direction A of the connecting member 200 and can be rotated relative to the connecting member 200. The first transmission member 320 can be replaced by a different type of transmission device, such as a linkage mechanism, which transmits a force and displacement through movement of a linkage. The second transmission member 330 is matched with the first transmission member 320 to jointly drive the plurality of abutting members 340 to move. The second transmission member is also arranged along the axial direction A of the connecting member 200 and sleeved on the connecting member 200.

In this embodiment, the plurality of abutting members 340 are arranged between the first transmission member 320 and the second transmission member 330 at intervals in sequence along the circumferential direction of the connecting member 200. The plurality of abutting members 340 have a main function that when the first transmission member 320 and the second transmission member 330 move, the plurality of abutting members 340 move towards or away from the connecting member 200, so as to achieve effect of clamping or releasing the connecting member 200. The abutting member 340 is usually made of high-hardness materials such as steel or cemented carbide to ensure that it can remain stable and reliable during clamping and releasing. In addition, in order to overcome a problem of insufficient friction between the plurality of abutting members 340 and the connecting member 200, a layer of elastic material can be coated on surfaces of the plurality of abutting members 340 to sequentially increase a frictional contact force, and the elastic material may be selected from materials such as silica gel and rubber.

During use of the rotating module 10 of this embodiment, the user can mount the photographic equipment (such as a camera, which is exemplified in this embodiment) on the rotating module 10 through the connecting member 200, and the housing 100 is connected to the tripod through an adapter or directly. When the camera and the tripod are assembled and the user does not drive the manipulation assembly 310, the rotating module 10 is in a locked state. At this time, the first transmission member 320 and the second transmission member 330 are matched with each other to make the plurality of abutting members 340 hold the connecting member 200 tightly, so as to lock rotation of the camera relative to the tripod and ensure stable connection between the camera and the tripod.

When the user needs to adjust a shooting angle of the camera, the manipulation assembly 310 is driven to move the first transmission member 320 and the second transmission member 330. Thus, the plurality of abutting members 340 are driven to move away from the connecting member 200 to release the connecting member 200, so that the connecting member 200 is no longer clamped by the plurality of abutting members 340, that is, the connecting member 200 can be freely rotated relative to the housing 100, and the user can directly rotate the camera at this time, so that the camera can be freely rotated relative to the tripod to adjust the shooting angle. After the shooting angle is adjusted, the user releases the manipulation assembly 310, and the first transmission member 320 and the second transmission member 330 are matched with each other again, so that the plurality of abutting members 340 clamp the connecting member 200 again to fix the camera at a new shooting angle.

In the technical scheme of this embodiment, the mounting cavity 100a is defined in the housing 100, which provides a mounting place for the locking mechanism 300 and the connecting member 200, and then the connecting member 200 can be unlocked or locked through the manipulation assembly 310, the first transmission member 320, the second transmission member 330, and the plurality of abutting members 340 of the locking mechanism 300. When the user needs to adjust a shooting position, the manipulation assembly 310 is operated to drive the first transmission member 320 and the second transmission member 330 to move, and thus drive the plurality of abutting members 340 to move towards or away from the connecting member 200, and the connecting member 200 can be quickly released to adjust the shooting angle and then locked after the angle is adjusted. This design enables the user to quickly clamp or release the connecting member 200 through a simple operation, for adjusting the shooting angle.

Referring to FIG. 3, in this embodiment, the first transmission member 320 includes a first annular transmission frame 322 and a second annular transmission frame 324. The first annular transmission frame 322 is abutted against the second annular transmission frame 324 and is relatively rotatably mounted at an opening of one end of the mounting cavity 100a.

The second transmission component 330 includes a third annular transmission frame 332 and a fourth annular transmission frame 334. The third annular transmission frame 332 is abutted against the fourth annular transmission frame 334 and is relatively rotatably mounted at an opening of the other end of the mounting cavity 100a.

The first annular transmission frame 322, the second annular transmission frame 324, the third annular transmission frame 332, and the fourth annular transmission frame 334 are each provided with a guiding structure 400. When the manipulation assembly 310 drives the first transmission member 320 and the second transmission member 330 to move, the first annular transmission frame 322 and the second annular transmission frame 324 can be driven to be rotated relative to each other, the third annular transmission frame 332 and the fourth annular transmission frame 334 can be driven to be rotated relative to each other, and the guide structure 400 can drive and guide the plurality of abutting members 340 to move towards the connecting member 200 to clamp the connecting member 200 or to move away from the connecting member 200 to release the connecting member 200.

In this embodiment, the first annular transmission frame 322 and the second annular transmission frame 324 are respectively mounted at the opening of one end of the mounting cavity 100a and are abutted against each other. The first annular transmission frame 322 and the second annular transmission frame 324 can be rotated relative to each other, and their relative movement can be realized by driving the manipulation assembly 310. When the manipulation assembly 310 is operated, the first annular transmission frame 322 and the second annular transmission frame 324 can be rotated relative to each other, thus driving the guide structure 400 to move. The guide structure 400 further guides the plurality of abutting members 340 to move towards the connecting member 200, so as to achieve the effect of clamping or releasing the connecting member 200.

The third annular transmission frame 332 and the fourth annular transmission frame 334 are mounted at the opening of the other end of the mounting cavity 100a and are abutted against each other. The third annular transmission frame 332 and the fourth annular transmission frame 334 are similar to the first annular transmission frame 322 and the second annular transmission frame 324, and drive the guide structure 400 to move through their relative rotation. Movement of the guide structure 400 guides the plurality of abutting members 340 to move towards the connecting member 200, so as to achieve the effect of clamping or releasing the connecting member 200. The guide structure 400 can be taken in various forms to realize guiding and driving of the abutting members 340. Its common structure includes a spiral groove or the like. For example, the spiral groove is arranged in an annular transmission frame, and ends of the abutting members 340 are matched with the spiral groove, and the abutting members 340 are driven to move along the spiral groove by way of rotation of the annular transmission frame, so as to achieve clamping or releasing.

In some embodiments, in order to reduce friction between the first annular transmission frame 322 and the second annular transmission frame 324, a ball bearing may be added or a lubricant may be used between them. For example, the ball bearing is arranged between contact surfaces of the two annular transmission frames, and the ball bearing can effectively reduce a friction force and improve transmission efficiency and stability. A lubricant such as lubricating oil or grease can be coated on the contact surfaces of the two annular transmission frames, which can reduce the friction and improve the transmission efficiency.

In actual use, when the user needs to adjust the shooting angle of the camera, the manipulation assembly 310 is operated. The manipulation assembly 310 drives the first annular transmission frame 322 and the second annular transmission frame 324 to rotate relative to each other through the transmission mechanism, while the third annular transmission frame 332 and the fourth annular transmission frame 334 are also rotated relative to each other. The guide structure 400 guides the plurality of abutting members 340 to move towards or away from the connecting member 200 with rotation of the annular transmission frame.

When the user rotates the manipulation assembly 310, the guide structure 400 drives the abutting members 340 to move towards the connecting member 200, so as to clamp the connecting member 200 and fix the camera firmly at a current angular position. In adjusting the shooting angle, the user rotates the manipulation assembly 310 again to move the abutting member 340 along the guide structure 400 and away from the connecting member 200, thus realizing releasing of the connecting member 200. At this time, the user can freely rotate the camera to adjust the shooting angle. After adjustment, the manipulation assembly 310 is operated again to move the abutting members 340 towards the connecting member 200 again, thus completing clamping and fixing.

Referring to FIGS. 2 and 3, in this embodiment, the guide structure 400 includes a group of guide holes 402, and guide holes in the group of guide holes 402 are sequentially arranged at intervals along the circumferential direction of the connecting member 200.

In this embodiment, the guide structure 400 adopts design of the group of guide holes 402. The guide holes in the group of guide holes 402 are sequentially arranged at intervals along the circumferential direction of the connecting member 200. Each of the guide holes is eccentrically arranged, so that the abutting member 340 can be driven to move in the guide hole, thus realizing clamping and releasing of the connecting member 200. For example, a plurality of groups of guide holes 402 are evenly distributed in the first annular transmission frame 322 and the second annular transmission frame 324, and in the third annular transmission frame 332 and the fourth annular transmission frame 334. When the annular transmission frames rotate, these groups of guide holes 402 guide and drive the abutting members 340 to change a movement direction in the guide holes of the group of guide holes 402, so as to achieve clamping or releasing the connecting member 200.

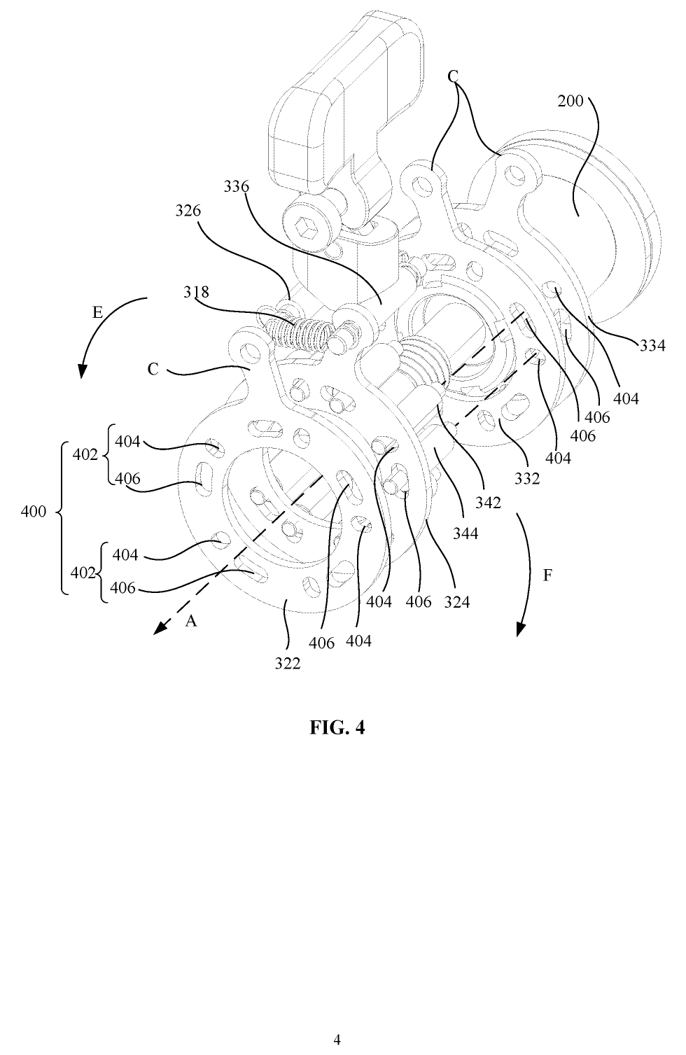

Referring to FIG. 4, in this embodiment, the group of guide holes 402 includes a plurality of first guide holes 404 and a plurality of second guide holes 406. The plurality of first guide holes 404 and the plurality of second guide holes 406 are alternately arranged in the first annular transmission frame 322, the second annular transmission frame 324, the third annular transmission frame 332, and the fourth annular transmission frame 334 at intervals.

One end of each of the plurality of abutting members 340 is respectively inserted into a first guide hole 404 and a second guide hole 406 that are staggered and respectively defined in the first annular transmission frame 322 and the second annular transmission frame 324, and the other end of the abutting member is inserted into a first guide hole 404 and a second guide hole 406 that are staggered and respectively defined in the third annular transmission frame 332 and the fourth annular transmission frame 334.

In this embodiment, the group of guide holes 402 includes two different types of guide holes: a first guide hole 404 and a second guide hole 406. The first guide hole 404 and the second guide hole 406 are different in shape and extension direction. Further, positions of the first guide hole 404 and the second guide hole 406 are also different. The second guide hole 406 is arranged eccentrically with respect to an axis of the connecting member 200, and the plurality of second guide holes 406 are all distributed eccentrically, thereby realizing control over the plurality of abutting members 340.

The first guide hole 404 may be circular or elliptical in shape, which is mainly configured to accurately guide linear movement of the abutting members 340. The second guide hole 406 may be rectangular or arc-shaped in shape, and is designed to be eccentrically arranged. An extended end of the second guide hole 406 is relatively deviated from the axis of the connecting member 200, which may guide the abutting member 340 to move along an eccentric trajectory when the annular transmission frames rotate, thus achieving more flexible clamping and releasing effect.

In an actual operation process, the user drives the first annular transmission frame 322 and the second annular transmission frame 324, and the third annular transmission frame 332 and the fourth annular transmission frame 334 to rotate by the manipulation assembly 310. The first guide hole 404 and the second guide hole 406 in the group of guide holes 402 guide the abutting member 340 to move in the guide holes. Due to eccentric design of the second guide hole 406, when the annular transmission frames rotate, the abutting member 340 may move along the eccentric trajectory, thus achieving the effect of clamping or releasing the connecting member 200.

Referring to FIG. 3, in this embodiment, the first guide hole 404 is arranged to extend along a radial direction of a central shaft of the connecting member 200, and the second guide hole 406 is arranged to extend along a circumferential direction of a shaft hole of the central shaft of the connecting member 200.

In this embodiment, the group of guide holes 402 includes a first guide hole 404 and a second guide hole 406, which are different in extension direction and function. The first guide hole 404 extends along a radial direction of the central shaft of the connecting member 200. The first guide hole 404 may be oval in shape. The first guide hole 404 is mainly configured to guide the abutting member 340 to move in the second guide hole 406. Due to its oval design, when the abutting member 340 moves in the second guide hole 406, a radial extension part of the first guide hole 404 can provide enough space to allow the abutting member 340 to move relatively away from the connecting member 200.

The second guide hole 406 is arranged to extend along a circumferential direction of the shaft hole of the central shaft of the connecting member 200 and is arranged eccentrically with respect to the axis of the connecting member 200. With its eccentric design, the second guide hole 406 guides the abutting member 340 to move relatively away from the connecting member 200 or towards the connecting member 200 when the annular transmission frames rotate, so as to realize clamping or releasing of the connecting member 200.

Referring to FIG. 3, in this embodiment, the plurality of abutting members 340 at least include a first roller shaft 342 and a second roller shaft 344.

One end of the first roller shafts 342 passes through the first guide hole 404 of the first annular transmission frame 322 and is inserted into the second guide hole 406 of the second annular transmission frame 324. The other end of the first roller shaft 342 passes through the second guide hole 406 of the third annular transmission frame 332 and is inserted into the first guide hole 404 of the fourth annular transmission frame 334.

One end of the second roller shafts 344 passes through the second guide hole 406 of the first annular transmission frame 322 and is inserted into the first guide hole 404 of the second annular transmission frame 324. The other end of the second roller shaft 344 passes through the first guide hole 404 of the third annular transmission frame 332 and is inserted into the second guide hole 406 of the fourth annular transmission frame 334.

In this embodiment, when the manipulation assembly 310 drives the first and second annular transmission frames 322 and 324 to rotate, the first guide hole 404 of the first annular transmission frame 322 drives the first roller shaft 342 to move in the second guide hole 406 of the second annular transmission frame 324. Meanwhile, the first guide hole 404 of the fourth annular transmission frame 334 drives the first roller shaft 342 to move in the second guide hole 406 of the third annular transmission frame 332. In this way, the first roller shaft 342 moves accurately in the guide holes of the two annular transmission frames, so as to realize clamping or releasing of the connecting member 200.

During a same operation, the first guide hole 404 of the second annular transmission frame 324 drives the second roller shaft 344 to move in the second guide hole 406 of the first annular transmission frame 322. Meanwhile, the second guide hole 406 of the third annular transmission frame 332 drives the second roller shaft 344 to move in the second guide hole 406 of the fourth annular transmission frame 334. In this way, the second roller shaft 344 moves in the guide holes of different annular transmission frames, thus realizing effective control over the connecting member 200.

With precise matching design of the roller shaft and the guide hole, stable clamping and releasing of the connecting member 200 can be realized when the first roller shaft 342 and the second roller shaft 344 move in the guide holes of the annular transmission frames. The first guide hole 404 and the second guide hole 406 guide moving trajectories of the roller shafts respectively, and meanwhile, their eccentric design enables the roller shafts to generate different moving trajectories when the annular transmission frames rotate, thus realizing control of clamping or releasing of the connecting member 200.

With continued reference to FIG. 3, in this embodiment, side edges of the first annular transmission frame 322, the second annular transmission frame 324, the third annular transmission frame 332, and the fourth annular transmission frame 334 are each provided with a transmission handle C.

A first driving linkage 326 is rotatably connected between the transmission handle C of the first annular driving frame 322 and the transmission handle C of the third annular driving frame 332.

A second driving linkage 336 is rotatably connected between the transmission handle C of the second annular transmission frame 324 and the transmission handle C of the fourth annular transmission frame 334.

The first driving linkage 326 and the second driving linkage 336 are driven by the manipulation assembly 310 to move away from each other to drive the first annular transmission frame 322 and the third annular transmission frame 332 to rotate in a first direction E, and the second annular transmission frame 324 and the fourth annular transmission frame 334 to rotate in a second direction F. Alternatively, the first driving linkage 326 and the second driving linkage 336 are driven by the manipulation assembly 310 to get close to each other to drive the first annular transmission frame 322 and the third annular transmission frame 332 to rotate in the second direction F, and the second annular transmission frame 324 and the fourth annular transmission frame 334 to rotate in the first direction E. The second direction F is opposite to the first direction E.

In this embodiment, side edges of the first annular transmission frame 322, the second annular transmission frame 324, the third annular transmission frame 332, and the fourth annular transmission frame 334 are each provided with a transmission handle C. The transmission handle C of the first annular transmission frame 322 and the transmission handle C of the third annular transmission frame 332 are rotatably connected with each other through the first driving linkage 326, and the transmission handle C of the second annular transmission frame 324 and the transmission handle C of the fourth annular transmission frame 334 are rotatably connected with each other through the second driving linkage 336. Arrangement of these transmission handles C and driving linkages realizes synchronous rotation of the annular driving frames and ensures stable control over the connecting member 200.

In an actual operation, the manipulation assembly 310 drives the first driving linkage 326 and the second driving linkage 336 to move. When the manipulation assembly 310 drives the first driving linkage 326 and the second driving linkage 336 away from each other, the first annular transmission frame 322 and the third annular transmission frame 332 are driven to rotate in the first direction E, while the second annular transmission frame 324 and the fourth annular transmission frame 334 are rotated in the opposite second direction F. Contrariwise, when the manipulation assembly 310 drives the first driving linkage 326 and the second driving linkage 336 to get close to each other, the first annular transmission frame 322 and the third annular transmission frame 332 are driven to rotate in the second direction F, while the second annular transmission frame 324 and the fourth annular transmission frame 334 are rotated in the opposite first direction E. The first direction E is opposite to the second direction F, which ensures that the annular transmission frames can be effectively clamped or released under different operating conditions.

With design of this embodiment, arrangement of the transmission handle C and the driving linkage enables the manipulation assembly 310 to accurately control rotation directions and amplitudes of the annular transmission frames, thus realizing efficient clamping and releasing of the connecting member 200. The first driving linkage 326 and the second driving linkage 336, when driven by the manipulation assembly 310, can synchronously drive a plurality of annular transmission frames to move in a coordinated manner. This design not only improves convenience and efficiency of operations, but also ensures stability and reliability of the connecting member 200. Matching of the transmission handle C and the driving linkage provides higher transmission accuracy and stability, which is suitable for various scenes that need to adjust the shooting angle frequently.

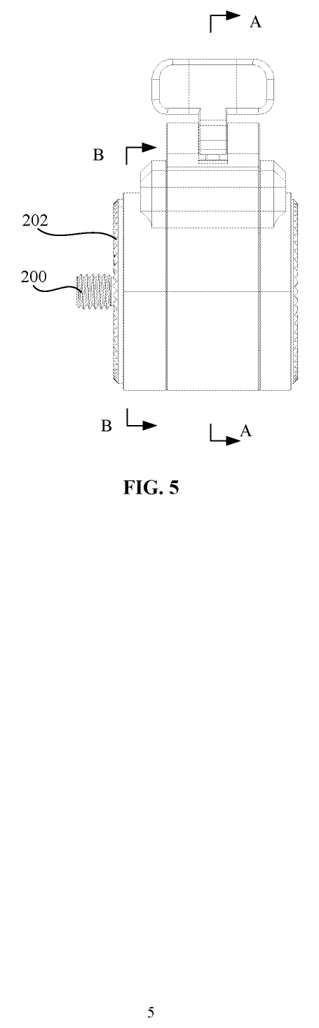

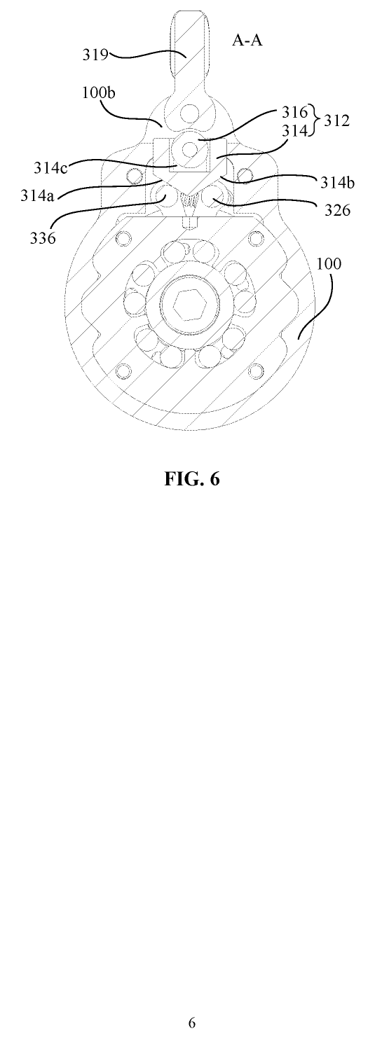

Referring to FIGS. 5 and 6, FIG. 5 is a side view of the rotating module 10 according to an embodiment of the present disclosure, and FIG. 6 is a schematic sectional view taken at A-A in FIG. 5.

In this embodiment, the manipulation assembly 310 includes:

an extrusion member 312 arranged on a side wall of the housing 100, the extrusion member 312 being at least partially located in the housing 100, an end of the extrusion member 312 located in the housing 100 being abutted against the first driving linkage 326 and the second driving link 336, and the extrusion member 312 being configured to move towards the connecting member 200 under an action of an external force to extrude and push the first driving linkage 326 and the second driving link 336 to be away from each other; and

an elastic piece 318 including at least one tension spring, one end of the tension spring being connected with the first driving linkage 326, and the other end of the tension spring being connected with the second driving linkage 336, and the tension spring being configured to pull the first driving linkage 326 and the second driving linkage 336 to get close to each other so as to drive the plurality of abutting members 340 to move towards the connecting member 200 and clamp the connecting member 200.

In this embodiment, the end of the extrusion member 312 located in the housing 100 is abutted against the first driving linkage 326 and the second driving linkage 336. Under an external force, the extrusion member 312 moves towards the connecting member 200, pushing the first driving linkage 326 and the second driving linkage 336 away from each other. The extrusion member 312 squeezes between the first driving linkage 326 and the second driving linkage 336 by its own volume, pushing the first driving linkage and the second driving linkage to move in opposite directions, thus realizing releasing of the abutting member 340.

The elastic piece 318 includes at least one tension spring with one end being connected with the first driving linkage 326 and the other end being connected with the second driving linkage 336. The tension spring is configured to pull the first driving linkage 326 and the second driving linkage 336 to get close to each other. When extrusion from the extrusion member 312 to the first driving linkage 326 and the second driving linkage 336 is removed, the elastic piece 318 pulls the first driving linkage 326 and the second driving linkage 336 back to their original positions, to move the abutting member 340 towards the connecting member 200 to realize clamping.

In this embodiment, the extrusion member 312 is arranged on the side wall of the housing 100, partially located in the housing 100, and is abutted against the first driving linkage 326 and the second driving linkage 336. When an external force acts on the extrusion member 312, the extrusion member 312 moves towards the connecting member 200, pushing the first driving linkage 326 and the second driving linkage 336 away from each other. The extrusion member 312 squeezes between the first driving linkage 326 and the second driving linkage 336 by its own volume to move the first driving linkage 326 and the second driving linkage 336 in opposite directions, thus realizing releasing of the abutting member 340.

When extrusion from the extrusion member 312 to the first driving linkage 326 and the second driving linkage 336 is removed, the elastic piece 318 pulls the first driving linkage 326 and the second driving linkage 336 back to their original positions. When the tension spring returns to its original state, the first driving linkage 326 and the second driving linkage 336 are pulled close to each other, thus driving the abutting member 340 to move towards the connecting member 200 and realizing clamping.

In this embodiment, matching of the extrusion member 312 and the elastic piece 318 realizes efficient control over the connecting member 200. The extrusion member 312 pushes the first driving linkage 326 and the second driving linkage 336 away from each other under the external force, thus realizing the releasing of the connecting member 200. The elastic piece 318 pulls the first driving linkage 326 and the second driving linkage 336 back to their original positions after the external force on the extrusion member 312 is removed, thus realizing the clamping of the connecting member 200. This design not only improves convenience and efficiency of operations, but also ensures stability and reliability after adjustment.

With continued reference to FIG. 6, in this embodiment, an outer side wall of the housing 100 is provided with two mounting parts 100b which are spaced apart along an axis of the connecting member 200.

### The manipulation assembly 310 further includes:

an unlocking handle 319, one end of which is rotatably connected with the two mounting parts 100b and configured to eject the extrusion member 312 to be exposed from an end of the side wall of the housing 100 in rotating.

In this embodiment, the manipulation assembly 310 not only includes the extrusion member 312 and the elastic piece 318, but also is provided with the unlocking handle 319. The unlocking handle 319 is connected with the mounting parts 100b of the outer side wall of the housing 100 to realize driving of the extrusion member 312, thereby controlling movement of the two driving linkages.

The outer side wall of the housing 100 is provided with two mounting parts 100b spaced apart along the axis of the connecting member 200. These two mounting parts 100b provide a fixed point for mounting of the unlocking handle 319, ensuring its stable operation. One end of the unlocking handle 319 is rotatably connected with the two mounting parts 100b (an expression “rotatably connected” mentioned in this embodiment may be “hinged”), and the other end of the unlocking handle 319 is configured to eject the extrusion member 312 in rotating, so that the extrusion member 312 is exposed from one end of the side wall of the housing 100, thereby realizing the driving of the extrusion member 312.

When the user needs to adjust the shooting angle of the camera, it can be achieved by operating the unlocking handle 319. The user turns the unlocking handle 319 to cause one end of the handle to be abutted against the extrusion member 312. Under an external force, the extrusion member 312 moves towards the connecting member 200, pushing the first driving linkage 326 and the second driving linkage 336 away from each other. In this way, the abutting member 340 is driven away from the connecting member 200, thus realizing releasing of the connecting member 200. At this time, the user can freely adjust the angle of the camera. After the adjustment is completed, the user releases the unlocking handle 319, and the extrusion member 312 is reset under an action of the elastic piece 318. The first driving linkage 326 and the second driving linkage 336 are pulled by the elastic piece 318 to get close to each other, which drives the abutting member 340 to clamp the connecting member 200 again, thus realizing stable fixing.

In this embodiment, matching of the unlocking handle 319 and the manipulation assembly 310 realizes efficient control over the connecting member 200. The unlocking handle 319 provides a stable operation basis through connection with the mounting part 100b. The user can simply rotate the unlocking handle 319 and eject the extrusion member 312 to realize driving of the two driving linkages, thus releasing or clamping the connecting member 200. This design not only improves convenience and efficiency of operations, but also ensures stability and reliability after adjustment. By providing the unlocking handle 319, it is more flexible and convenient for the user to adjust the angle of the camera, which is suitable for various scenes that need to adjust the shooting angle frequently.

With continued reference to FIG. 6, in this embodiment, the extrusion member 312 includes:

a pushing rod 314, an end of the pushing rod 314 away from the connecting member 200 being exposed outside the housing 100 and provided with a mounting groove 314c; and

a roller 316 rotatably mounted in the mounting groove 314c, the roller 316 being configured to be in rolling contact with an end of the unlocking handle 319.

In this embodiment, the end of the pushing rod 314 away from the connecting member 200 is provided with the mounting groove 314c, and the roller 316 is mounted in the mounting groove 314c. The roller 316 is rotatably mounted in the mounting groove 314c for rolling contact with the end of the unlocking handle 319. When the user operates the unlocking handle 319, the handle rotates and comes into contact with the roller 316. The roller 316 can smoothly transmit a force exerted by the handle, push the pushing rod 314 to move towards the connecting member 200, and drive the first driving linkage 326 and the second driving linkage 336 away from each other, thus realizing releasing of the abutting members 340. Design of the roller 316 ensures smoothness and fluency of operations, reduces friction and wear, and improves durability of the system.

With continued reference to FIG. 6, in this embodiment, an end of the pushing rod 314 abutted against the first driving linkage 326 and the second driving linkage 336 is configured with a first extrusion surface 314a and a second extrusion surface 314b, the first extrusion surface 314a and the second extrusion surface 314b are inclined and extend towards each other, the first extrusion surface 314a abuts against the second driving linkage 336, and the second extrusion surface 314b abuts against the first driving linkage 326.

In this embodiment, the end of the pushing rod 314 is configured with the first extrusion surface 314a and the second extrusion surface 314b, and these extrusion surfaces gradually decrease in a direction from the side to the central axis along the axial direction of the pushing rod 314. The first extrusion surface 314a and the second extrusion surface 314b may be inclined surfaces or arc surfaces. When the pushing rod 314 moves towards the connecting member 200, the first driving linkage 326 and the second driving linkage 336 slide along the first extrusion surface 314a and the second extrusion surface 314b, respectively. Design of the inclined surfaces or the arc surfaces enables the driving linkage to be subjected to a stable and uniform extrusion force during a moving process, thereby realizing effective control over the connecting member 200.

When the user operates the unlocking handle 319, the unlocking handle 319 drives the pushing rod 314 to move towards the connecting member 200. The first extrusion surface 314a and the second extrusion surface 314b of the pushing rod 314 start to contact with the first driving linkage 326 and the second driving linkage 336, and gradually increase the force. As the pushing rod 314 continues to move, the first driving linkage 326 and the second driving linkage 336 slide along the inclined or arc extrusion surfaces and are gradually pushed away. In this way, the abutting member 340 is driven away from the connecting member 200, thus realizing releasing of the connecting member 200.

In this embodiment, design of the first extrusion surface 314a and the second extrusion surface 314b of the pushing rod 314 provides significant operational advantages. Design of the inclined surfaces or arc surfaces ensures stability and fluency of the driving linkage in the moving process. Design of the inclined surfaces enables the driving linkage to be subjected to a uniform force distribution in sliding, which reduces sudden friction and resistance. The design of arc surfaces not only provides a smooth sliding path, but also reduces friction and improves driving efficiency.

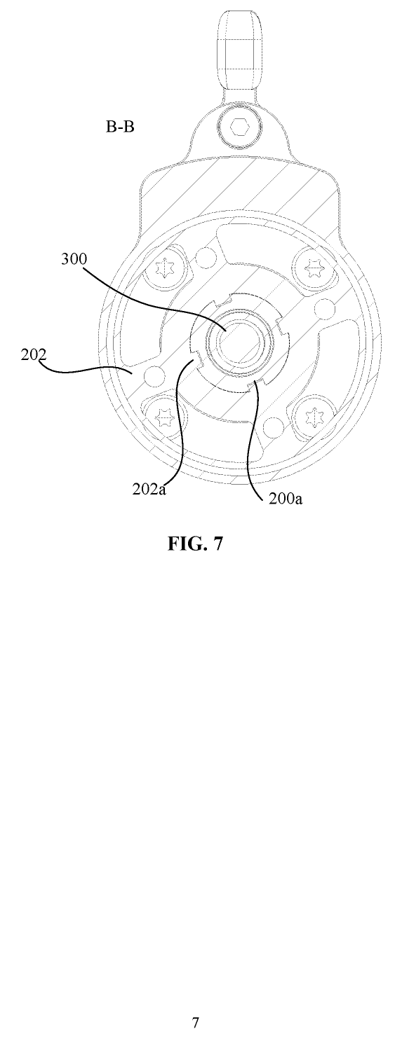

Referring to FIG. 7, in this embodiment, the rotating module 10 further includes:

an abutting disc 202 rotatably arranged at an end of the housing 100. The abutting disc 202 is connected with a part of the connecting member 200 extending out of the mounting cavity 100a and is configured to be abutted against components connected with the connecting member 200.

In this embodiment, a main function of the abutting disc 202 is to contact with a bottom of the camera to provide a stable connection surface and ensure stability of the camera after mounting. With arrangement of the abutting disc 202, a stress of the connecting member 200 can be effectively dispersed, stability of the whole structure can be improved, and the camera can be prevented from shaking during use.

Further, in order to avoid slipping between the abutting disc 202 and the bottom of the camera, in this embodiment, a plurality of antiskid teeth may be provided on a surface of the abutting disc 202 that contacts with the bottom of the camera. These antiskid teeth can significantly increase the friction force and ensure that the camera remains stable during shooting. Design of the antiskid teeth not only prevents displacement of the camera, but also absorbs vibration to a certain extent, thus improving quality and effect of shooting. The antiskid teeth may have various shapes, such as a sawtooth, a cone, or a diamond, to achieve optimal antiskid effect.

In some embodiments, at least one clamping groove 200a is defined in an outer side wall of an end of the connecting member 200 extending out of the mounting cavity 100a.

At least one protrusion 202a is provided in the abutting disc 202, and the at least one protrusion 202a is clamped and matched with the at least one clamping groove 200a.

In this embodiment, the at least one clamping groove 200a is arranged in the outer side wall of the end of the connecting member 200 extending out of the mounting cavity 100a, and the at least one protrusion 202a is provided on the abutting disc 202. These protrusions 202a are clamped and matched with the clamping grooves 200a. When the connecting member 200 is clamped by the plurality of abutting members 340, matching of the protrusions 202a with the clamping grooves 200a ensures that rotation of the abutting disc 202 is effectively limited. This design not only enhances the transmission stability between the abutting disc 202 and the connecting member 200, but also improves the reliability of the whole structure.

When the abutting disc 202 is tried to be rotated in a locking state, the protrusions 202a may be clamped in the locking groove 200a, thus preventing free rotation of the abutting disc 202. In this way, even if it is influenced by external force during shooting, the abutting disc 202 can remain stable and not rotate at will, ensuring that the shooting angle of the camera does not change.

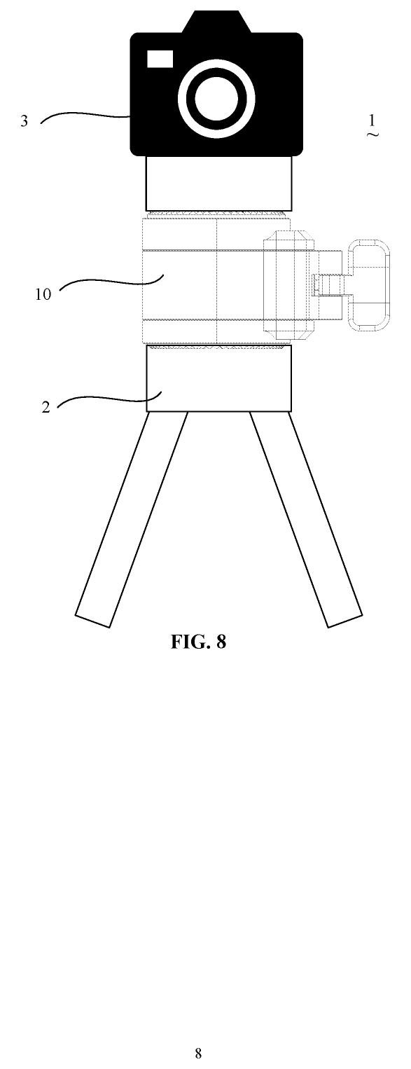

Referring to FIG. 8, a photographic device 1 is further provided in the disclosure, which includes a photographic bracket 2, a photographic equipment 3, and the rotating module 10. A specific structure of the rotating module 10 can be referred to the above embodiments. As the photographic device 1 adopts all of technical solutions of all of the above embodiments, it has at least all of technical effects brought by the technical solutions of the above embodiments, which will not be described here again. A fixing member of the rotating module 10 is detachably connected with the photographic bracket 2, and the abutting disc 202 of the rotating module 10 is detachably connected with the photographic equipment 3.

In this embodiment, the photographic device 1 includes the photographic bracket 2, the photographic equipment 3, and the rotating module 10. The photographic bracket 2 can be a tripod, a hand-held stand, etc., for providing stable support. The photographic equipment 3 may be a camera, a video camera, etc., for taking still images or videos. The fixing member of the rotating module 10 is detachably connected with the photographic bracket 2, and the abutting disc 202 of the rotating module 10 is detachably connected with the photographic equipment 3, thus ensuring convenience of mounting and disassembly.

The photographic device 1 of the disclosure is mainly used in the field of photography, and is suitable for various shooting scenes, such as product photography, portrait photography, landscape photography, and so on. For example, the camera can be fixed on the rotating module 10, the rotating module 10 is mounted on the tripod and provided with stable support through the tripod. Design of the rotating module 10 allows the user to easily adjust the angle of the camera so as to ensure the optimal shooting angle and framing.

With design of this embodiment, the photographic device 1 achieves efficient and stable photographing effect. With introduction of the rotating module 10, the shooting angle of the camera and the video camera can be quickly and accurately adjusted in a shooting process, which meets needs of different scenes. There are a variety of choices for the tripod and the hand-held stand, which provides flexibility in fixed and mobile shooting. Design of detachable connection increases portability and ease of use of equipment, making it easy for photographers to mounting and adjust the equipment.

The above is only a part or preferred embodiments of the disclosure, and neither the text nor the figures can serve to limit the protection scope of the disclosure. Any equivalent structural transformation made under a concept integral with the disclosure using the specification and drawings of the present disclosure, which is directly or indirectly applied to other related technical fields, is included within the protection scope of the disclosure.

What is claimed is:

1. A rotating module for connecting photographic equipment, the rotating module comprising:
a housing defined with a mounting cavity inside;
a connecting member disposed through the mounting cavity and capable of being movable or fixed relative to the housing, the connecting member being configured to be connected with the photographic equipment; and
a locking mechanism arranged in the housing, the locking mechanism comprising a manipulation assembly, a first transmission member, a second transmission member, and a plurality of abutting members, the first transmission member and the second transmission member being oppositely arranged along an axial direction of the connecting member and sleeved on the connecting member, the plurality of abutting members being arranged between the first transmission member and the second transmission member at intervals in sequence along a circumferential direction of the connecting member, and the plurality of abutting members being respectively connected with the first transmission member and the second transmission member and capable of moving towards or away from the connecting member; the manipulation assembly being arranged at an outer wall of the housing, an execution end of the manipulation assembly extending into the housing and being in drive connection with the first transmission member and the second transmission member, for driving the first transmission member and the second transmission member to move to drive the plurality of the abutting members to move towards the connecting member to clamp the connecting member so as to fix an shooting angle of the photographic equipment, or to move away from the connecting member to release the connecting member to make the shooting angle of the photographic equipment adjustable.

2. The rotating module according to claim 1, wherein the first transmission member comprises a first annular transmission frame and a second annular transmission frame, the first annular transmission frame being docked with the second annular transmission frame and being relatively rotatably mounted at an opening of one end of the mounting cavity;
the second transmission component comprises a third annular transmission frame and a fourth annular transmission frame, the third annular transmission frame being docked with the fourth annular transmission frame and being relatively rotatably mounted at an opening of the other end of the mounting cavity; and
wherein the first annular transmission frame, the second annular transmission frame, the third annular transmission frame, and the fourth annular transmission frame are each provided with a guiding structure corresponding to the plurality of abutting members, and the plurality of abutting members are movably connected with the guiding structures; in case the manipulation assembly drives the first transmission member and the second transmission member to move, the first annular transmission frame and the second annular transmission frame are rotated relative to each other, the third annular transmission frame and the fourth annular transmission frame are rotated relative to each other, and the guide structures guide the plurality of abutting members to move towards the connecting member to clamp the connecting member or to move away from the connecting member to release the connecting member.

3. The rotating module according to claim 2, wherein the guide structure comprises a group of guide holes, guide holes in the group of guide holes being sequentially arranged at intervals along the circumferential direction of the connecting member.

4. The rotating module according to claim 3, wherein the group of guide holes comprises a plurality of first guide holes and a plurality of second guide holes defined in the first annular transmission frame, the second annular transmission frame, the third annular transmission frame, and the fourth annular transmission frame, the plurality of first guide holes and the plurality of second guide holes are sequentially and alternately arranged at intervals; and
one end of each of the plurality of abutting members is inserted into a first guide hole and a second guide hole that are staggered and respectively defined in the first annular transmission frame and the second annular transmission frame, and the other end of the abutting member is inserted into a first guide hole and a second guide hole that are staggered and respectively defined in the third annular transmission frame and the fourth annular transmission frame.

5. The rotating module according to claim 4, wherein the first guide hole is arranged to extend along a radial direction of a central axis of the connecting member, and the second guide hole is arranged to extend along a circumferential direction of a central axis of the connecting member.

6. The rotating module according to claim 4, wherein the plurality of abutting members at least comprise a first roller shaft and a second roller shaft; wherein
one end of the first roller shaft passes through the first guide hole of the first annular transmission frame and is inserted into the second guide hole of the second annular transmission frame, and the other end of the first roller shaft passes through the second guide hole of the third annular transmission frame and is inserted into the first guide hole of the fourth annular transmission frame; and
one end of the second roller shaft passes through the second guide hole of the first annular transmission frame and is inserted into the first guide hole of the second annular transmission frame, and the other end of the second roller shaft passes through the first guide hole of the third annular transmission frame and is inserted into the second guide hole of the fourth annular transmission frame.

7. The rotating module according to claim 2, wherein side edges of the first annular transmission frame, the second annular transmission frame, the third annular transmission frame and the fourth annular transmission frame are each provided with a transmission handle; wherein
a first driving linkage is connected between the transmission handle of the first annular transmission frame and the transmission handle of the third annular transmission frame; and
a second driving linkage is connected between the transmission handle of the second annular transmission frame and the transmission handle of the fourth annular transmission frame; and
wherein the first driving linkage and the second driving linkage are driven by the manipulation assembly to move away from each other to drive the first annular transmission frame and the third annular transmission frame to rotate in a first direction, and to drive the second annular transmission frame and the fourth annular transmission frame to rotate in a second direction; or, the first driving linkage and the second driving linkage are driven by the manipulation assembly to get close to each other to drive the first annular transmission frame and the third annular transmission frame to rotate in the second direction, and to drive the second annular transmission frame and the fourth annular transmission frame to rotate in the first direction; and the second direction is opposite to the first direction.

8. The rotating module according to claim 7, wherein the manipulation assembly comprises:
an extrusion member arranged on a side wall of the housing, the extrusion member being at least partially located in the housing, an end of the extrusion member located in the housing being abutted against the first driving linkage and the second driving link, and the extrusion member being configured to move towards the connecting member under an action of an external force to extrude and push the first driving linkage and the second driving link away from each other; and
an elastic piece comprising at least one tension spring, one end of the tension spring being connected with the first driving linkage, and the other end of the tension spring being connected with the second driving linkage, and the tension spring being configured to pull the first driving linkage and the second driving linkage to get close to each other.

9. The rotating module according to claim 8, wherein an outer side wall of the housing is provided with two mounting parts which are spaced apart along an axis of the connecting member; and
the manipulation assembly further comprises:
an unlocking handle, one end of the unlocking handle being rotatably connected with the two mounting parts and configured to eject the extrusion member to be exposed from an end of the side wall of the housing in rotating.

10. The rotating module according to claim 9, wherein the extrusion member comprises:
a pushing rod, an end of the pushing rod away from the connecting member being exposed outside the housing and provided with a mounting groove; and
a roller rotatably mounted in the mounting groove, the roller being in rolling contact with an end of the unlocking handle.

11. The rotating module according to claim 10, wherein an end of the pushing rod abutted against the first driving linkage and the second driving linkage is configured with a first extrusion surface and a second extrusion surface, the first extrusion surface and the second extrusion surface are inclined and extend towards each other, the first extrusion surface abuts against the second driving linkage, and the second extrusion surface abuts against the first driving linkage.

12. The rotating module according to claim 1, further comprising:
an abutting disc arranged at an end of the housing, the abutting disc being connected with a part of the connecting member extending out of the mounting cavity and being configured to be abutted against component connected with the connecting member.

13. The rotating module according to claim 12, wherein at least one clamping groove is defined in an outer side wall of an end of the connecting member extending out of the mounting cavity; and
at least one protrusion is provided on the abutting disc, the at least one protrusion being clamped and matched with the at least one clamping groove.

14. A photographic device, comprising a photographic bracket, a photographic equipment, and the rotating module according to claim 1, wherein one end of the rotating module is detachably connected with the photographic bracket, and the other end of the rotating module is detachably connected with the photographic equipment.
